(19) United States
(12) Patent Application Publication
(10) Pub. No.: US 2025/0223840 A1
(43) Pub. Date: Jul. 10, 2025

(54) AUTO-OPEN DOOR-LOCK DEVICE FOR HOME APPLIANCE

(71) Applicant: DUAL POWER ELECTRONICS CO., LTD, Jeongeup-si, Jeollabuk-do (KR)

(72) Inventors: Jang-Joo LIM, Seoul (KR); Sang-Won SUH, Jeongeup-si (KR); Jung Gil LEE, Jeongeup-si (KR); Hee Chang KIM, Jeongeup-si (KR)

(73) Assignee: DUAL POWER ELECTRONICS CO., LTD, Jeongeup-si, Jeollabuk-do (KR)

(21) Appl. No.: 18/852,730

(22) PCT Filed: Mar. 28, 2023
(86) PCT No.: PCT/KR2023/004104

§ 371 Date: Sep. 30, 2024

(30) Foreign Application Priority Data
Mar. 13, 2023 (KR) 10-2023-0032298

(51) Int. Cl. E05B 47/00; E05B 65/00

(52) U.S. Cl. CPC E05B 47/0012; E05B 65/00; E05B 2047/0017; E05B 2047/002

(57) ABSTRACT

An auto-open door-lock device according to an example embodiment relates to an auto-open door-lock device including a body cover with a space inside and a motor installed inside the body cover to provide a driving force, and includes a locker configured to couple with or decouple from a hook coming in from outside through rotation; a locker shaft having its one end connected to the locker and formed at the center of rotation of the locker; a protruding piece configured to connect to another end of the locker shaft and to induce rotation of the locker; a locker spring configured to connect to one side of the locker and to provide a rotational restoring force to the locker; a rack slide configured to provide a rotational force of the motor to the locker; and a pinion gear configured to transmit the rotational force of the motor to the rack slide.

### TECHNICAL FIELD

The present invention relates to a door-lock device for home appliance and, more particularly, to a door-lock device installed in a washing machine and a dryer.

### RELATED ART

There are various types of home appliances in our daily lives. In particular, a home appliance that is used by inserting contents, for example, a washing machine, a dryer, a dishwasher, a microwave oven, and the like, is installed with a door to block the inserted contents from the outside. A locking device that opens and closes the door is an essential part that constitutes the corresponding home appliance.

Until recently, various techniques related to a door-lock device are developed. Representative examples include Korean Patent Registration No. 10-1667916 (Door-lock apparatus for push and push) and Korean Patent Registration No. 10-1915250 (Manual door-lock device).

The door-lock apparatus for push and push relates to a door-lock device that automatically opens a door without a need for a user to open the door when an operation of a corresponding home appliance is terminated.

The door-lock apparatus for push and push includes a release button installed inside a body and configured to release a locked locker by releasing a binding force of a fastening member through a sliding operation and a driving unit configured to selectively control a door holding operation, a door locking operation, and an automatic door opening operation by a rotational operation of a rotational shaft with a cam protrusion on one side. However, the above device has the complicated overall configuration and control since the driving unit and a sensing member detect a locking or unlocking operation of the locker by detecting a position of the cam protrusion.

The manual door-lock device relates to a door-lock device that may be manually operated with a simple structure, which differs from an existing method that is electronically operated by a solenoid.

However, the manual door-lock device above adopts a manual control method that requires an action of a user, which somewhat is opposite to the trend of home appliances aiming for convenience.

As an automatic door-lock device, Korean Patent Registration No. 10-2356893 (2022.01.25.) titled “Auto-open door-look equipment of electronic household” (hereinafter, “893 Patent”) describes an automatic opening (auto-open) door-look device that automatically unlocks and opens a door when a washing machine or a dryer stops operating.

However, in 893 Patent, coupling of a rack slide for rotating a locker and a shaft that is a rotational shaft of the locker is connected to a clutch gear and a rachet and a pawl are coupled inside the clutch gear (see FIG. 3 of 893 Patent). In the door-lock device in this structure, deformation of a mechanism or shaking of the locker by separation between the ratchet and the pawl occurred continuously at rotation of the locker repeating opening and closing hundreds to thousands of times. Also, since the clutch gear meshes with a gear formed at the end of the rack slide, it is difficult to reduce tolerance occurring during a processing process and production cost may arise due to a complex machine structure.

Therefore, it is necessary to reduce a defect rate by reducing tolerance coming from processing of parts, to improve the structure to prevent its shaking in order to induce accurate rotation of a locker, and to reduce production cost of product by reducing the number of parts.

### DETAILED DESCRIPTION

### Technical Subject

An objective of the present invention is to provide an automatic opening (auto-open) door-lock device that has a simple configuration, has few failures, and enables stable locking and unlocking.

### Technical Solution

An automatic opening (auto-open) door-lock device according to an example embodiment relates to auto-open door-lock device including a body cover with a space inside and a motor installed inside the body cover to provide a driving force, and includes a locker configured to couple with or decouple from a hook coming in from outside through rotation; a locker shaft having its one end connected to the locker and formed at the center of rotation of the locker; a protruding piece configured to connect to another end of the locker shaft and to induce rotation of the locker; a locker spring configured to connect to one side of the locker and to provide a rotational restoring force to the locker; a rack slide configured to provide a rotational force of the motor to the locker; and a pinion gear configured to transmit the rotational force of the motor to the rack slide, wherein the rack slide includes a track hole that is a space formed to rotate the protruding piece in a predetermined area of one end; a rack gear configured to mesh with the pinion gear in a predetermined area of another end; and a stopper formed at one end of the track hole to induce the protruding piece to rotate.

The auto-open door-lock device according to an example embodiment further includes a slide spring having its one end coupling with the body cover and having another end connected to the rack slide, and configured to linearly move the rack slide in the direction of the locker.

The auto-open door-lock device according to an example embodiment further includes a locker locking slide configured to insert into a locker fastening groove formed in the locker and to block rotation of the locker.

As an example embodiment, a hinge portion configured to extend passing the protruding piece formed at the other end of the locker shaft and to rotatably connect to the body cover is included.

As an example embodiment, the pinion gear includes a first pinion gear and a second pinion gear configured to share the center of rotation and to couple in a longitudinal direction, and the second pinion gear has gear teeth only in a predetermined area on the outer circumferential surface.

As an example embodiment, the second pinion gear may mesh with the rack gear.

### Effect

An automatic opening (auto-open) door-lock device according to an example embodiment has a relatively simple structure, is relatively inexpensive to manufacture, and is possible to secure durability.

Also, compared to the conventional door-lock device, it may be implemented in a compact size, which is advantageous in securing a space.

Also, it is possible to reduce a defect rate and there is no risk of breakdown due to a precise rotation of a locker.

### BRIEF DESCRIPTION OF DRAWINGS

FIG. 1 is a front view of an automatic opening (auto-open) door-lock device according to an example embodiment.

FIG. 2 is an exploded perspective view of an auto-open door-lock device according to an example embodiment.

FIG. 3 is a detailed perspective view of a locker according to an example embodiment.

FIG. 4 is a perspective view of a rack slide according to an example embodiment.

FIG. 5 is a perspective view of a pinion gear according to an example embodiment.

FIG. 6 is a driving state view of a rack slide according to an example embodiment.

### MODE

Specific structural or functional descriptions related to example embodiments according to the concept of the present invention set forth herein are simply provided to explain the example embodiments according to the concept of the present invention and the example embodiments according to the concept of the present invention may be implemented in various forms and are not limited to the example embodiments described herein.

Various modifications may be made to the example embodiments according to the concept of the present invention. Therefore, the example embodiments are illustrated in the drawings and are described in detail with reference to the detailed description. However, the example embodiments are not construed as being limited to the specific disclosure and should be understood to include all changes, equivalents, and replacements within the idea and the technical scope of the present invention.

Although terms of “first,” “second,” and the like may be used to explain various components, the components are not limited to such terms. These terms are used only to distinguish one component from another component. For example, a first component may be referred to as a second component, or similarly, the second component may be referred to as the first component without departing from the scope according to the concept of the present invention.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly accessed” to another component, still other component may not be present therebetween. Likewise, expressions, for example, “between” and “immediately between” and “adjacent to” and “immediately adjacent to” may also be construed as described in the foregoing.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings. However, the scope of the claims is not limited to or restricted by such example embodiments. Like reference numerals refer to like components throughout.

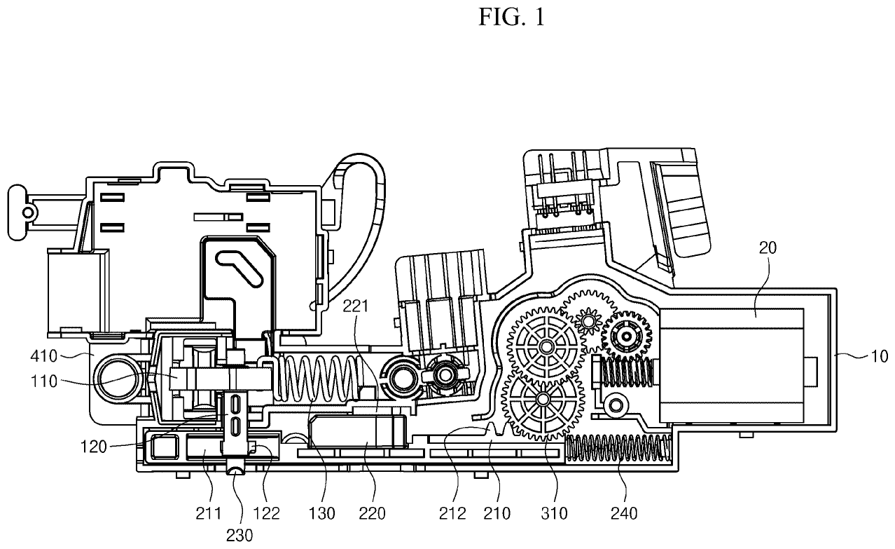

FIG. 1 is a front view of an automatic opening (auto-open) door-lock device according to an example embodiment.

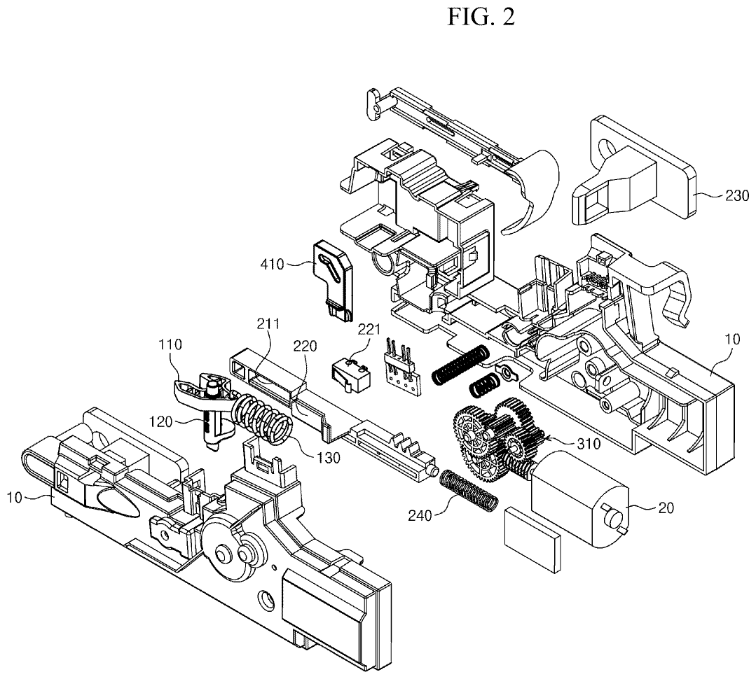

FIG. 2 is an exploded perspective view of an auto-open door-lock device according to an example embodiment.

Referring to FIGS. 1 and 2, an auto-open door-lock device according to an example embodiment relates to an auto-open door-lock device including a body cover 10 with a space inside and a motor 20 installed in the body cover 10 to provide a driving force, and includes a locker 110 configured to couple with or decouple from a hook coming in from outside through rotation, a locker shaft 120 having its one end connected to the locker 110 and formed at the center of rotation of the locker 110, a protruding piece 122 configured to connect to another end of the locker shaft 120 and to induce rotation of the locker, a locker spring 130 configured to connect to one side of the locker 110 and to provide a rotational restoring force to the locker 110, a rack slide 210 configured to provide a rotational force of the motor 20 to the locker, and a pinion gear 310 configured to transmit the rotational force of the motor 20 to the rack slide 210. The rack slide 210 includes a track hole 211 that is a space formed to rotate the protruding piece 122 in a predetermined of one end, a rack gear 212 configured to mesh with the pinion gear 310 in a predetermined area of another end, and a stopper 213 formed at one end of the track hole 211 to induce the protruding piece 122 to rotate.

In general, the locker 110 is a place with which a hook attached to a door of a home appliance couples, and is configured to rotate at a predetermined angle. The locker 110 is a place with which the hook couples and directly receives load and may be made of metal alloy or plastic to ensure rigidity as much as possible. The locker 110 may be implemented in various shapes, and may be in an angled ring shape with one side open as shown in FIGS. 1 and 2.

The locker 110 is designed to rotate at a set angle, and when a coupling portion of the hook is introduced into the locker 110, the locker 110 may rotate to prevent the hook from being separated in the same direction, and, when the locker 110 may rotate back to the angle at which the hook is introduced, the hook may be decoupled.

One end of the locker shaft 120 is connected to the locker 110. The locker shaft 120 and the locker 110 may be integrally formed, or may be firmly assembled with the locker 110. In particular, the locker shaft 120 may simultaneously perform a function of a rotational shaft around which the locker 110 rotates.

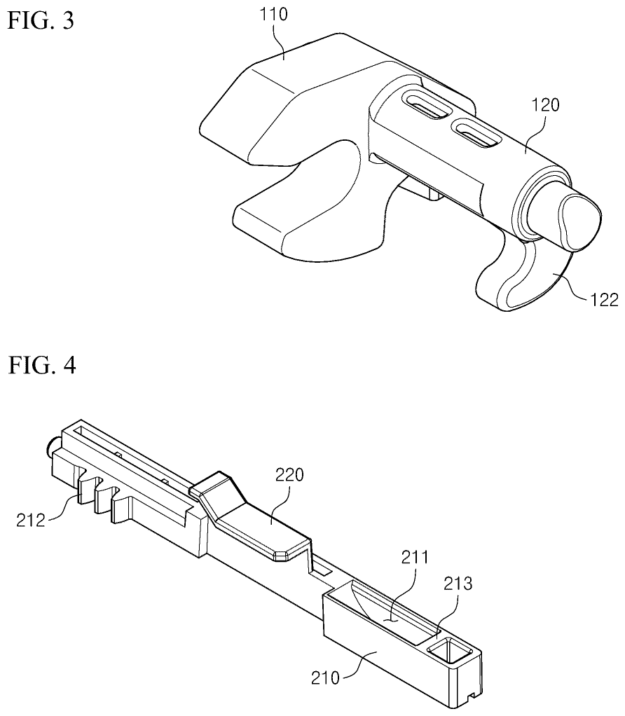

FIG. 3 is a detailed perspective view of a locker according to an example embodiment.

Referring to FIG. 3, the locker shaft 120 is coupled at the center of the locker 110, and the locker 110 rotates based on the locker shaft 120 in response to insertion and removal of the hook. The protruding piece 122 connected to the other end of the locker shaft 120 to induce rotation of the locker 110 surrounds a portion of the circumference of the locker shaft 120, but is formed with a protruding area.

Also, referring to FIGS. 1, 2, and 3, the auto-open door-lock device according to an example embodiment includes a hinge portion 230 configured to extend passing the protruding piece 122 formed at the other end of the locker shaft 120 and to rotatably connect to the body cover 10. The hinge portion 230 couples with the body cover 10. Therefore, the locker 110 may be free from failures, such as shaking or separation of the locker 110, despite the impact of the hook when the locker shaft 120 rotates.

This may guarantee the rotational stability of the locker compared to a case in which one end of the conventional locker shaft is made of a gear.

Rotation of the locker 110 by the locker shaft 120 and a rotation method of the hinge portion 230 are further described below.

The locker spring 130 is connected to one side of the locker 110, more specifically, to the opposite side of a coupling area of the hook couples around the locker shaft 120. Also, one end of the locker spring 130 is fastened to a wall of the body cover 10 to provide a continuous elastic force to the locker 110. The locker spring 130 applies the elastic force in the direction of the locker 110 at all times. As shown in FIGS. 1 and 2, when connecting the locker spring 130 to the locker 110, the locker 110 may maintain a rotational angle in an always-closed or always-open state.

That is, the locker 110 may not be in an intermediate closed or open state due to the elastic force (repulsion or repulsive force) applied by the locker spring 130. The elastic force (repulsion or repulsive force) of maintaining the closed state in which the hook is introduced is continuously applied to the locker. When the hook is removed from the locker 110 due to an external force and the locker 110 is opened, the locker 110 is maintained in the open state without rotating by way of the locker spring 130 unless another external force acts.

That is, as shown in FIGS. 1 and 2, the locker spring 130 may be firmly connected to the locker 110 in such a manner that its one end is fastened to a hole to be formed at the rear of the locker 110. In a state in which the hook is introduced and coupled with the locker 110, the locker spring 130 is in a state in which minimal load is applied. Also, when the hook retreats and decouples from the locker 110, minimal load is applied to the locker spring 130 connected to the locker 110 and the open state is maintained.

The rack slide 210 is in a long column shape and is installed to slidably perform linear motion on the body cover 10. The rack slide 210 may be a plastic or a metal material, but is not limited thereto.

As shown in FIGS. 1 and 2, the rack slide 210 includes the track hole 211 that is the space formed to rotate the protruding piece 122 in the predetermined area of one end, the rack gear 212 configured to mesh with the pinion gear 310 in the predetermined area of the other end, and the stopper 213 formed at one end of the track hole 211 to induce the protruding piece 122 to rotate. Also, a micro switch 220 is formed between the track hole 211 and the rack gear 212.

When the hook inserts into the locker 110 and rotates, the protruding piece 122 freely rotates within the track hole 211. When the rack slide 210 moves in the direction of a slide spring 240, the protruding piece 122 meets the stopper 213 and the movement of the rack slide 210 rotates the protruding piece 122 in contact with the stopper 213. Due to rotation of the protruding piece 122, the locker shaft 120 rotates and, at the same time, the locker 110 releases the fastened hook and the door is automatically opened.

FIG. 4 is a perspective view of a rack slide according to an example embodiment.

The surface of the rack slide 210 on which the track hole 211 is formed and the surface of the rack slide 210 on which the rack gear 212 is formed may differ from each other, but are not necessarily limited thereto.

Also, the micro switch 220 formed between the track hole 211 and the rack gear 212 has a conductive electrode made of a conductive material, so may control the motor 220 in such a manner that the conductive electrode is electrically connected to a switch terminal 221 and transmits an electrical signal to the auto-open door-lock device.

The switch terminal 221 is installed at a position corresponding to the micro switch 220 to generate a control signal according to a position of the rack slide 210.

The pinion gear 310 may be directly connected to the motor 20 or may be connected to the motor 20 in conjunction with several gears, and is a gear that directly rotates with the rotational force of the motor 20.

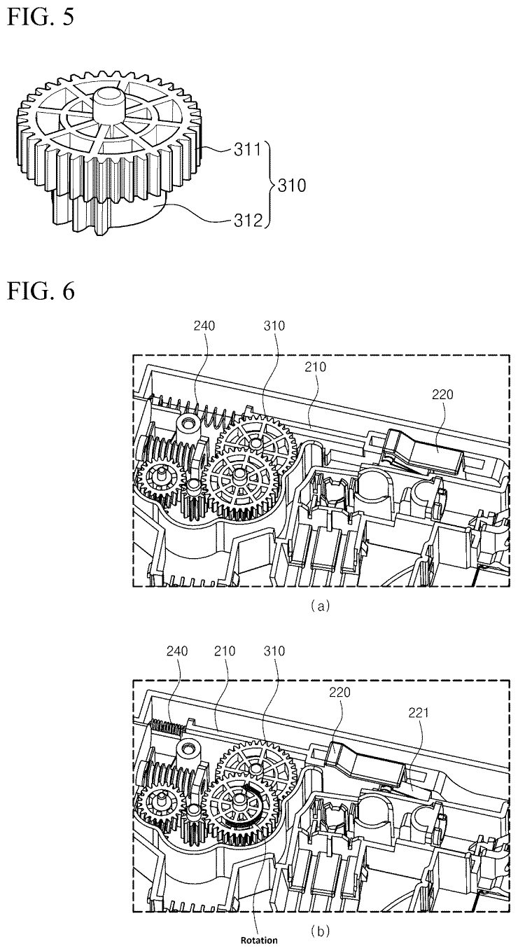

FIG. 5 is a perspective view of a pinion gear according to an example embodiment.

Referring to FIG. 5, the pinion gear 310 includes a first pinion gear 311 and a second pinion gear 312 configured to share the center of rotation and to couple in a longitudinal direction, and the second pinion gear 312 may have gear teeth only in a predetermined area on the outer circumferential surface.

The rack gear 212 of the rack slide 210 couples with the second pinion gear 312 and the first pinion gear 311 connects to a gear that is directly or indirectly connected to the motor 20, such that the motor 20 rotates, the first pinion gear 311 rotates, and, at the same time, the second pinion gear 312 rotates. Here, the second pinion gear 312 rotates by meshing with the rack gear 212 and gear teeth, but in a certain section in which there is no gear tooth, the rack gear 212 is not restricted by the rotational force of the motor 20 and may freely transfer the rack slide 210 toward the stopper 213.

The auto-open door-lock device according to an example embodiment includes the slide spring 240 and a locker locking slide 410.

One end of the slide spring 240 couples with the body cover 10 and another end thereof is connected to the rack slide 210 to linearly move the rack slide 210 in the direction of the stopper 213.

That is, in a state in which the rack gear 212 formed in the rack slide 210 and the second pinion gear 312 are engaged, the rack slide 210 is bound by the rotational force of the motor 20 and moves in the direction of the motor 20. However, in an area in which there is no gear tooth in the second pinion gear 312, the rack slide 210 is not affected by the rotational force of the motor 20 and moves in the direction of the clutch gear 230 by way of the slide spring 240.

Describing the movement of the rack slide 210 by the slide spring 240, the locker locking slide 410 moves in the direction of the locker 110 and couples with a locker fastening groove (not shown) to fasten the locker 110. A linear movement method of the locker locking slide 410 may be variously implemented.

In particular, when a protruding area facing the direction of the locker 110 drives the home appliance in a closed state in which the locker 110 is coupled with the hook, the locker locking slide 410 serves to prevent rotation of the locker 110 such that the locker 110 and the hook are not separated by the external force.

Main components that constitute the auto-open door-lock device according to an example embodiment are described. Hereinafter, a driving method of the auto-open door-lock device according to an example embodiment is further described with reference to FIG. 6.

FIG. 6 is a driving state view of a rack slide according to an example embodiment.

As shown in (a) of FIG. 6, the rack slide 210 is placed at the origin in a state in which the slide spring 240 is tensioned. Here, the micro switch 220 and the switch terminal 221 are connected to generate a first control signal. When the rack slide 210 is placed at the origin, the user may open and close the door of the home appliance without difficulty. Also, when placed in an origin state, the locker locking slide 410 may be operated to put the locker 110 into a locked state.

On the contrary, when the motor 20 rotates as shown in (b) of FIG. 6, the pinion gear 310 rotates and moves the rack slide 210 in the direction of the slide spring 240. In a situation of (b), the micro switch 220 and the switch terminal 221 generate a second control signal to prevent excessive external force from being applied to the locker 110 and to prevent the locker locking slide 410 from flowing in the direction of the locker 110, and if the locker 110 is locked with the locker locking slide 410, unlocks this to prevent the excessive external force from being applied to the motor 20.

Although the present invention is described with reference to the example embodiments illustrated in drawings, it is provided as an example only and it will be apparent to one of ordinary skill in the art that various modification and other equivalent embodiments may be made from the description. For example, suitable results may be achieved if the described techniques are performed in different order, and/or if components in a described system, architecture, device, or circuit are combined in a different manner, and/or replaced or supplemented by other components or their equivalents. Therefore, the true technical scope of the present invention should be determined by the technical spirit of the claims.

What is claimed is:

1. An automatic opening (auto-open) door-lock device comprising a body cover with a space inside and a motor installed inside the body cover to provide a driving force, the auto-open door-lock device comprising:
a locker configured to couple with or decouple from a hook coming in from outside through rotation;
a locker shaft having its one end connected to the locker and formed at the center of rotation of the locker;
a protruding piece configured to connect to another end of the locker shaft and to induce rotation of the locker;
a locker spring configured to connect to one side of the locker and to provide a rotational restoring force to the locker;
a rack slide configured to provide a rotational force of the motor to the locker; and
a pinion gear configured to transmit the rotational force of the motor to the rack slide,
wherein the rack slide comprises:
a track hole that is a space formed to rotate the protruding piece in a predetermined area of one end;
a rack gear configured to mesh with the pinion gear in a predetermined area of another end; and
a stopper formed at one end of the track hole to induce the protruding piece to rotate.

2. The auto-open door-lock device of claim 1, further comprising:
a slide spring having its one end coupling with the body cover and having another end connected to the rack slide, and configured to linearly move the rack slide in the direction of the locker.

3. The auto-open door-lock device of claim 1, further comprising:
a locker locking slide configured to insert into a locker fastening groove formed in the locker and to block rotation of the locker.

4. The auto-open door-lock device of claim 1, comprising:
a hinge portion configured to extend passing the protruding piece formed at the other end of the locker shaft and to rotatably connect to the body cover.

5. The auto-open door-lock device of claim 1, wherein the pinion gear includes a first pinion gear and a second pinion gear configured to share the center of rotation and to couple in a longitudinal direction, and the second pinion gear has gear teeth only in a predetermined area on the outer circumferential surface.

6. The auto-open door-lock device of claim 5, wherein the second pinion gear is configured to mesh with the rack gear.
